(19) United States
(12) Patent Application Publication
(10) Pub. No.: US 2023/0153575 A1
(43) Pub. Date: May 18, 2023

(54) ELECTRONIC DEVICE AND CONVOLUTIONAL NEURAL NETWORK TRAINING METHOD

(71) Applicants: Inventec (Pudong) Technology Corporation, Shanghai (CN); INVENTEC CORPORATION, TAIPEI CITY (TW)

(72) Inventors: Wan-Ting HSIEH, TAIPEI CITY (TW); Hao-Chun YANG, TAIPEI CITY (TW); Trista Pei-Chun CHEN, TAIPEI CITY (TW)

(21) Appl. No.: 17/654,400

(22) Filed: Mar. 10, 2022

(30) Foreign Application Priority Data
Nov. 12, 2021 (CN) 202111339262.7

(51) Int. Cl. G06N 3/04; G06N 3/08

(52) U.S. Cl. CPC G06N 3/0454; G06N 3/08

(57) ABSTRACT

The present disclosure provides an electronic device including a processor and a memory device. The memory device is configured to store a residual neural network group for restoring data and a multi-head neural network. The multi-head neural network contains multiple of self-attention neural modules. The processor is configured to perform the following steps. Multiple pieces of data corresponding to multiple of leads are input into residual neural network groups, respectively, to generate multiple of feature map groups respectively correspond to the leads. The feature map groups are classified to the self-attention neural modules according to labels of the feature map groups.

### CROSS-REFERENCE TO RELATED APPLICATION

This application claims priority to China Application Serial Number 202111339262.7, filed Nov. 12, 2021 which is herein incorporated by reference in its entirety.

### BACKGROUND

### Field of Invention

The disclosure relates to an electronic device, particularly to an electronic device and a convolutional neural network training method.

### Description of Related Art

In nowadays techniques, deep learning has being increasingly used for assisting determinations from human being. However, since labels of training data related to the medical images are often given by professionals and are integrated by major databases, the source domain bias might be generated in this case. Furthermore, if the same machine is trained by data including different diseases, determination accuracy of the machine for the different diseases may decrease. Therefore, how to improve the source domain bias and improve the determination accuracy for different diseases are important issues in the technique field.

### SUMMARY

One embodiment of the present disclosure provides an electronic device. The electronic device includes a processor and a memory device. The memory device is configured to store a plurality of residual neural network groups and a multi-attention network. The multi-attention network comprises a plurality of self-attention modules. The processor is configured to perform the following steps. A plurality of pieces of data corresponding to a plurality of leads are inputted to the residual neural network groups, respectively, to generate a plurality of feature map groups corresponding to the leads, respectively. The feature map groups are classified to the self-attention modules according to a plurality of labels of the feature map groups. A plurality of output feature maps are generated from the self-attention modules. The output feature maps respectively corresponding to the labels.

The other embodiment of the present disclosure provides a convolutional neural network training method. The convolutional neural network training method includes the following steps. A plurality of pieces of data corresponding to a plurality of leads are received. A plurality of feature map groups respectively corresponding to the leads are generated according to the pieces of data. The feature map groups are classified to the self-attention modules according to a plurality of labels of the feature map groups. The self-attention modules have different functions. The labels correspond to a plurality of diseases, respectively. A plurality of output feature map are generated according to the feature map groups, by the self-attention modules.

In summary, the present disclosure utilizes the multi-attention network to generate different functions according to different diseases, in order to improve the determination accuracy for different diseases.

### BRIEF DESCRIPTION OF THE DRAWINGS

FIG. 1 is a schematic diagram of an electronic device in accordance with one embodiment of the present disclosure.

FIG. 2 is a schematic diagram of a neural network structure in accordance with one embodiment of the present disclosure.

FIG. 3 is a schematic diagram of a residual neural network group in accordance with one embodiment of the present disclosure.

FIG. 4 is a schematic diagram of a residual neural network in accordance with one embodiment of the present disclosure.

FIG. 5 is a schematic diagram of leads in accordance with one embodiment of the present disclosure.

FIG. 6 is a schematic diagram of leads in accordance with one embodiment of the present disclosure.

FIG. 7 is a schematic diagram of a convolutional neural network training method in accordance with one embodiment of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present disclosure. That is, these details of practice are not necessary in parts of embodiments of the present disclosure. Furthermore, for simplifying the diagrams, some of the conventional structures and elements are shown with schematic illustrations.

The terms used in this specification and claims, unless otherwise stated, generally have their ordinary meanings in the art, within the context of the disclosure, and in the specific context where each term is used. Certain terms that are used to describe the disclosure are discussed below, or elsewhere in the specification, to provide additional guidance to the practitioner skilled in the art regarding the description of the disclosure.

It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

In this document, the term “coupled” may also be termed “electrically coupled,” and the term “connected” may be termed “electrically connected.” “Coupled” and “connected” may also be used to indicate that two or more elements cooperate or interact with each other. In the following description and in the claims, the terms “include” and “comprise” are used in an open-ended fashion, and thus should be interpreted to mean “include, but not limited to.” As used herein, the term “and/or” includes any and all combinations of one or more of the associated listed items.

Twelve leads of an electrocardiogram include three limb leads, three augmented limb leads and six chest leads. The aforementioned leads are composed by ten electrode patches. The limb leads can be implemented by Einthoven's triangle of disposing four electrode patches on left and right hands and left/right leg. The chest leads can be implemented by the other six electrode patches, by disposing the six electrode patches on the chest as positive polarities, and Wilson central terminal can be constructed as negative polarity. In usual, six limb leads can be indicated to I, II, III, aVL, aVR and aVF; and six chest leads be implemented by V1, V2, V3, V4, V5 and V6. By observing waveforms of twelve leads of an electrocardiogram can know the subject's heart activity, and it can be determined whether the subject's heart activity being in normal or some kind diseases may be found.

In the measuring process of electrocardiograms, disposed positions of the electrode patches, subject's status and environmental factors may generate interference signals, and labels of the electrocardiograms used for training data are usually given by lots of professionals. As a result, even if the data is received from the same database, domain bias still exists.

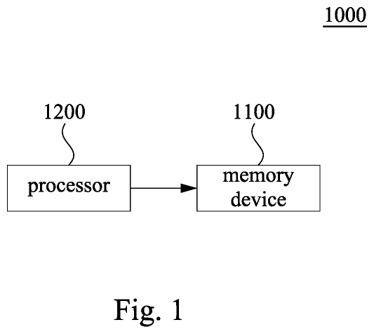

A description is provided with reference to FIG. 1. FIG. 1 is a schematic diagram of an electronic device 1000 in accordance with one embodiment of the present disclosure. The electronic device 1000 includes a processor 1200 and a memory device 1100 electrically coupled to the processor 1200.

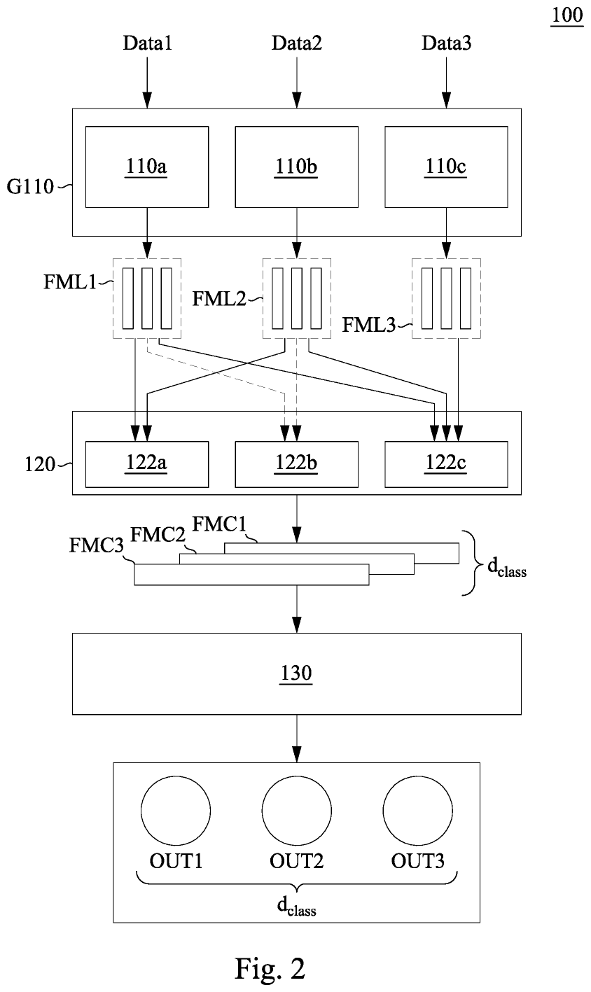

A description is provided with reference to FIG. 2. FIG. 2 is a schematic diagram of a neural network structure 100 in accordance with one embodiment of the present disclosure. As shown in FIG. 2, the neural network structure 100 includes a residual neural network structure G110, a multi-attention network 120 and a fully connected neural network 130. The neural network structure 100 can be store in the memory device 1100 of the electronic device 1000, and the neural network structure 100 can be executed by the processor 1200 in the electronic device 1000. In the present disclosure, all of functions of the neural network structure 100 can be executed/performed by the processor 1200.

In functions, the residual neural network structure G110 is configured to receive pieces of data Data1, Data2 and Data3 corresponding to the different leads, and the residual neural network structure G110 generates feature map groups FML1, FML2 and FML3 according to the pieces of data Data1, Data2 and Data3. The multi-attention network 120 is configured to receive the feature map groups FML1, FML2 and FML3, and the multi-attention network 120 generates output feature maps FMC1, FMC2 and FMC3 according to the feature map groups FML1, FML2 and FML3. The fully connected neural network 130 is configured to receive the output feature maps FMC1, FMC2 and FMC3, and the fully connected neural network 130 generates output values OUT1, OUT2 and OUT3 according to the output feature maps FMC1, FMC2 and FMC3. The output values OUT1, OUT2 and OUT3 are respectively correspond to different diseases (the different diseases are indicated to the different labels in the present disclosure as an example). In the training process, after inputting the pieces of data Data1, Data2 and Data3 to the neural network structure 100, weights of each of the residual neural network structure G110, the multi-attention network 120 and the fully connected neural network 130 can be adjusted according to the output value OUT1, OUT2 and OUT3 and multiple labels of each pieces of data Data1, Data2 and Data3.

Specifically, the residual neural network structure G110 includes residual neural network groups 110a, 110b and 110c. In the electrocardiograms, there are obviously differences between waveforms of different leads, and therefore, in the present disclosure, the pieces of data Data1, Data2 and Data3 correspond to different leads are respectively inputted to the residual neural network groups 110a, 110b and 110c, in order to respectively training the residual neural network groups 110a, 110b and 110c corresponding to the different leads.

For example, if the piece of data Data1 corresponds to the limb lead I, the residual neural network group 110a is configured to extract the feature map group FML1 corresponding to the limb lead I. If the piece of data Data2 corresponds to the limb lead II, the residual neural network group 110b is configured to extract the feature map group FML2. If the piece of data Data3 corresponds to the limb lead III, the residual neural network group 110c is configured to extract the feature map group FML3. And, the residual neural network structure G110 transmits the feature map groups FML1, FML2 and FML3, respectively generated by the residual neural network groups 110a, 110b and 110c, to the multi-attention network 120.

To be noted that, although FIG. 1 illustrates three residual neural network groups 110a, 110b and 110c, the neural network structure 100 in the present disclosure can includes more number of (such as, 4, 6, 8 or 12) residual neural network groups to respectively correspond to 4, 6, 8 or 12 leads. Therefore, it is not intend to limit the present disclosure.

The multi-attention network 120 includes self-attention modules 122a, 122b and 122c. In functions, the self-attention modules 122a, 122b and 122c can be distinguished by different diseases. And, in the mapping space of input data to the label, each of the self-attention modules 122a, 122b and 122c receives a part of the feature map groups FML1, FML2 and FML3 with a corresponding label. The labels in the present disclosure are indicated to different type of disease, and the self-attention modules 122a, 122b and 122c are configured to construct/establish models with different functions according to the different type of disease.

For example, if both of the pieces of data Data1 and Data2 have multiple labels respectively corresponding to atrioventricular obstruction, sinus arrhythmia, and sinus bradycardia. And, the piece of data Data3 has a label corresponding to the sinus bradycardia. As a result, the self-attention module 122a receives the feature map groups FML1 and FML2 with one label (such as, a label corresponds to the atrioventricular obstruction) of the multiple labels, according to the one label of the multiple labels. The self-attention module 122b receives the feature map groups FML1 and FML2 with another one label (such as, a label corresponds to the sinus arrhythmia) of the multiple labels, according to another one label of the multiple labels. The self-attention module 122c receives the feature map group FML3 with the other label (such as, a label corresponds to the sinus bradycardia) of the multiple labels, according to the other label of the multiple labels.

Therefore, the self-attention modules 122a, 122b and 122c can correspondingly output the output feature maps FMC1, FMC2 and FMC3 according to the feature map groups with the specific disease (corresponds to specific disease). As a result, the output feature map FMC1 corresponds to the one of the multiple labels (such as, the label corresponds to the atrioventricular obstruction), the output feature map FMC2 corresponds to the another one of the multiple labels (such as, the label corresponds to the sinus arrhythmia), and the output feature map FMC3 corresponds to the other one of the multiple labels (such as, the label corresponds to the sinus bradycardia). In other words, the multi-attention network 120 is configured to generate output feature maps FMC1, FMC2 and FMC3 with different classifications dclass. The classifications dclass of the output feature maps FMC1, FMC2 and FMC3 can be distinguished by diseases.

And, since the self-attention modules 122a, 122b and 122c are trained according to different input data, and the self-attention modules 122a, 122b and 122c have the different functions. The function of each self-attention modules 122a, 122b and 122c has multiple weights corresponding to one of the diseases. Each of the self-attention modules 122a, 122b and 122c can mask a part of the weights with relatively small values, and correspondingly adjust the other part of the weights with relatively large values to a sum of the other part of the weights becomes 1.

For example, the function of the self-attention module 122a includes three weights respectively correspond to the limb lead I, the limb lead II and the limb lead III. If the weight correspond to the limb lead III is less than a threshold and less than the weights correspond to the limb lead I and the limb lead II, the self-attention module 122a sets the weight correspond to the limb lead III as 0, and correspondingly adjusts the weights correspond to the limb lead I and the limb lead II, so as to train the self-attention module 122a according to the limb lead I and the limb lead II with higher quality.

In some embodiments, the model of each self-attention modules 122a, 122b and 122c can be implemented by the following function.

$$Attention ( Q , K , V ) = softmax ( \frac{Q {K}^{T}}{\sqrt{{d}_{k}}} )$$

The Q, K, V in the above function can be indicated as query, key and value, which can derived from a linear projection of the lead embedding.

To be noted that, although FIG. 1 illustrates three self-attention modules 122a, 122b and 122c, the neural network structure 100 in the present disclosure can includes more number of (such as, 26 or 27) self-attention modules to respectively correspond to 26 or 27 diseases. Therefore, it is not intend to limit the present disclosure.

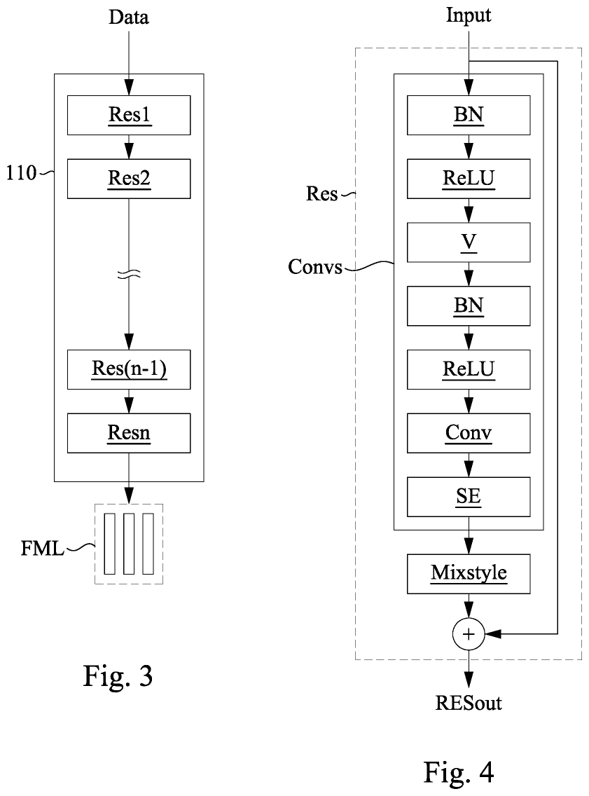

A description is provided with reference to FIG. 3. FIG. 3 is a schematic diagram of a residual neural network group 110 in accordance with one embodiment of the present disclosure. Each of the residual neural network groups 110a, 110b and 110c can be implemented by the residual neural network groups 110 in FIG. 3, and the feature map group FML outputted by the residual neural network groups 110 can also be realized as the feature map group FML1, FML2 or FML3. As shown in FIG. 3, the residual neural network group 110 includes continuous residual neural networks Res1˜Resn, the said “n” can be any positive integer. In some embodiments, the said “n” can be implemented by 4, 6, 8 or other proper number of layers. A first one of the continuous residual neural networks Res1˜Resn (such as the residual neural network Res1) is configured to receive input data Data, and a last one of the continuous residual neural networks Res1˜Resn (such as the residual neural network Resn) is configured to generate and output the feature map group FML.

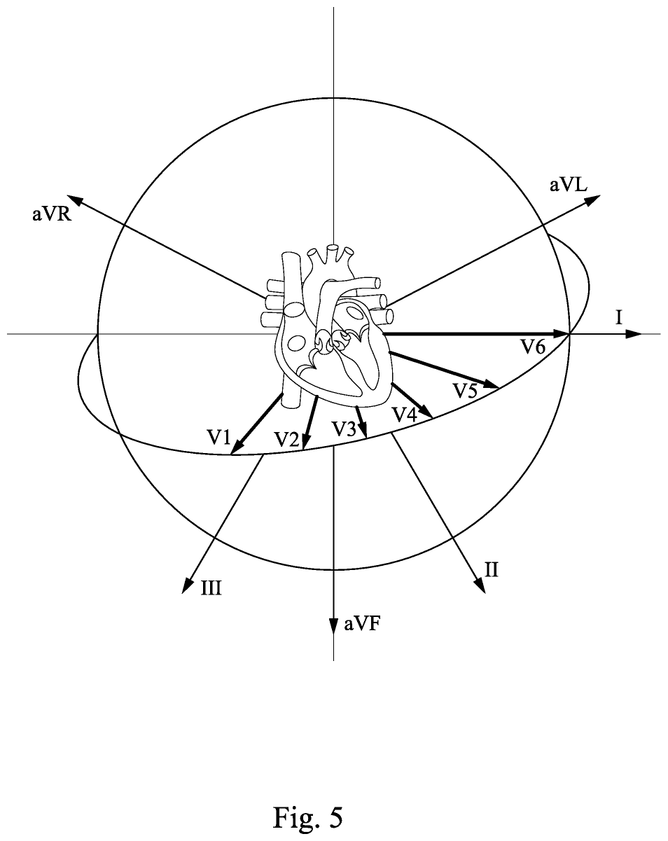

A description is provided with reference to FIG. 4. FIG. 4 is a schematic diagram of a residual neural network Res in accordance with one embodiment of the present disclosure. Each of the residual neural networks Res1˜Resn in FIG. 3 can be implemented by the residual neural network Res in FIG. 4. As shown in FIG. 4, the residual neural network Res includes a convolutional neural network Convs and a mixed layer Mixstyle. The convolutional neural network Convs includes a batch normalization layer BN, a linear rectifier function layer ReLU, a convolutional layer Cony and a compression and excitation layer SE.

The convolutional neural network Convs is configured to receive the input data Input, and the convolutional neural network Convs transmits the first feature map to the mixed layer Mixstyle.

The mixed layer Mixstyle is configured to shuffle a sequence of the first feature map in a batch dimension to generate a second feature map, and the mixed layer Mixstyle mixes the first feature map and the second feature map to generate a third feature map according to a mixed model. The mixed model can be implemented by the following function.

$$MixStyle ( F , {F}^{′} ) = {γ}_{mix} ⊙ \frac{F - μ ( F )}{σ ( F )} + {β}_{m i x} ; \\ {γ}_{mix} = λσ ( F ) + ( 1 - λ ) σ ( {F}^{′} ) ; \\ {β}_{m i x} = λ μ ( F ) + ( 1 - λ ) μ ( {F}^{′} ) ;$$

In the above function, if a variable F is substituted by the first feature map, and the variable F′ is substituted by the second feature map, a calculated value of the mixed model is a third feature map. The residual neural network Res generates a fourth feature map RESout according to the third feature map and the input data Input, and the residual neural network Res transmits the fourth feature map RESout as another input data to next residual neural network. In other words, the fourth feature map RESout is transmitted as input data to a second one of the continuous residual neural networks (such as, the residual neural network Res2).

In the above function, mixed layer mixes the first feature map and the second map to the third feature map with new style. Factors μ(F) and μ(F′) can be implemented by average values of F and F′, and factors σ(F) and σ(F′) can be implemented by standard values of F and F. Coefficients γₘᵢₓ and βₘᵢₓ are affine transformation coefficients. And, in the function, λ≅Beta(α), wherein the parameter can be substituted by 0.1.

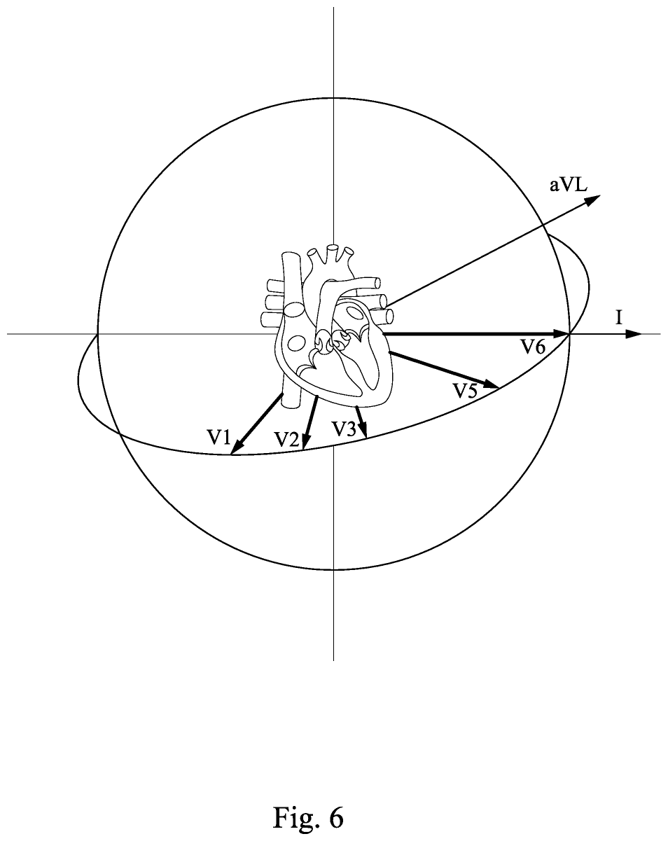

A description is provided with reference to FIG. 5. FIG. 5 is a schematic diagram of leads in accordance with one embodiment of the present disclosure. The leads as shown in FIG. 5 include limb leads aVR, aVF, aVL, I, II and III and chest leads V1˜V6. In usual, the machine is trained by data with 12 leads, and during the test and use process of the machine, data also need to be contained with complete 12 leads.

A description is provided with reference to FIG. 6. FIG. 6 is a schematic diagram of a leads in accordance with one embodiment of the present disclosure. The leads as shown in FIG. 6 include limb leads aVL and I and chest leads V1, V2, V3, V5 and V6. The present disclosure utilizes mixed layer MixStyle to reduce the domain bias of the data, and utilizes the multi-attention network 120 to classify the feature map groups FML1, FML2 and FML3 to the self-attention modules 122a, 122b and 122c according to the different diseases, and the self-attention module 122a, 122b and 122c are able to utilize the less number of the leads to determine the corresponding disease. Therefore, the neural network structure 100 can utilize part of the leads (such as, the limb leads VL and I and chest leads V1, V2, V3, V5 and V6) to determine the specific diseases.

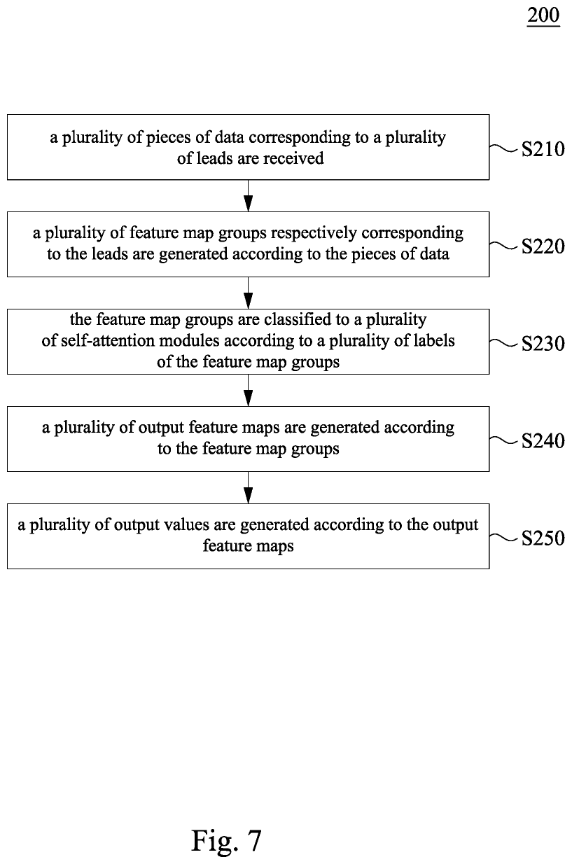

A description is provided with reference to FIG. 7. FIG. 7 is a schematic diagram of a convolutional neural network training method 200 in accordance with one embodiment of the present disclosure. The convolutional neural network training method 200 includes steps S210˜S250. The steps S210˜S250 can be performed by the processor 1200.

In step S210, a plurality of pieces of data corresponding to a plurality of leads are received. The pieces of data corresponding the leads are received are received by the residual neural network groups.

In step S220, a plurality of feature map groups respectively corresponding to the leads are generated according to the pieces of data. The feature map groups respectively corresponding to the leads are generated, by the residual neural network groups, according to the pieces of data.

In step S230, the feature map groups are classified to a plurality of self-attention modules according to a plurality of labels of the feature map groups. The feature map groups are classified, according to the multi-attention network, to the self-attention modules according to the labels of the feature map groups. And, the labels corresponding to multiple diseases.

In step S240, a plurality of output feature maps are generated according to the feature map groups. The output feature maps are respectively generated from the self-attention modules in the multi-attention network according to the classification of the feature map groups.

In step S250, a plurality of output values are generated according to the output feature maps. The output values are generated by the fully connected neural network according to the output feature maps. And, the output values correspond to the multiple diseases.

In summary, the present disclosure utilizes the mixed style MixStyle to reduce the source domain bias of the data, and utilizes the multi-attention network 120 to generate different functions according to different diseases, in order to improve the determination accuracy for different diseases, and the weights with relatively small values are adjusted to 0, so as to reduce the number of leads during testing and utilizing process.

Although specific embodiments of the disclosure have been disclosed with reference to the above embodiments, these embodiments are not intended to limit the disclosure. Various alterations and modifications may be performed on the disclosure by those of ordinary skills in the art without departing from the principle and spirit of the disclosure. Thus, the protective scope of the disclosure shall be defined by the appended claims.

What is claimed is:

1. An electronic device, comprising:
a processor; and
a memory device, the memory device is configured to store a plurality of residual neural network groups and a multi-attention network, wherein the multi-attention network comprises a plurality of self-attention modules, wherein the processor is configured to:
input a plurality of pieces of data corresponding to a plurality of leads to the residual neural network groups, respectively, to generate a plurality of feature map groups corresponding to the leads, respectively;
classify the feature map groups to the self-attention modules according to a plurality of labels of the feature map groups; and
generate a plurality of output feature maps according to the feature map groups, wherein the output feature maps respectively corresponding to the labels.

2. The electronic device of claim 1, wherein each of the self-attention modules has a plurality of weights corresponding to one of the leads.

3. The electronic device of claim 1, wherein the memory device is further configured to store a fully connected neural network, wherein the processor is further configured to:
inputting the output feature maps to the fully connected neural network to generate a plurality of output values according the output feature maps, wherein the output values are respectively correspond to the labels.

4. The electronic device of claim 1, wherein each of the residual neural network groups comprises:
a plurality of continuous residual neural networks, wherein a first one of the continuous residual neural networks comprises:
a convolutional neural network, configured to generate a first feature map according to one of the pieces of data corresponding to one of the leads; and
a mixed layer, configured to:
shuffle a sequence of the first feature map in a batch dimension to generate a second feature map; and
mix the first feature map and the second feature map to generate a third feature map according to a mixed model;
wherein the first one of the continuous residual neural networks generates a fourth feature map, according to the third feature map and the one of the pieces of data, an wherein the first one of the continuous residual neural networks transmits the fourth feature map as an input data to a second one of the continuous residual neural networks.

5. The electronic device of claim 4, wherein the mixed model is MixStyle(F, F′), wherein,
$$MixStyle ( F , {F}^{′} ) = {γ}_{mix} ⊙ \frac{F - μ ( F )}{σ ( F )} + {β}_{m i x} ; \\ {γ}_{mix} = λσ ( F ) + ( 1 - λ ) σ ( {F}^{′} ) ; \\ {β}_{m i x} = λ μ ( F ) + ( 1 - λ ) μ ( {F}^{′} ) ;$$
wherein if a variable F is substituted by the first feature map, and the variable F′ is substituted by the second feature map, a calculated value of the mixed model is the third feature map.

6. The electronic device of claim 4, wherein at last one of the continuous residual neural networks is configured to generate one of the feature map groups.

7. The electronic device of claim 4, wherein the convolutional neural network comprises a batch normalization layer, a linear rectifier function layer, a convolutional layer, and a compression and excitation layer.

8. The electronic device of claim 1, wherein each of the self-attention modules mask a part of weights with relatively small values, such that a sum of the part of the weights is 0.

9. The electronic device of claim 8, wherein in response to that the part of the weights with relatively small values are masked by each of the self-attention modules, the self-attention modules correspondingly adjust values of the other part of the weights with relatively large values.

10. The electronic device of claim 1, wherein the processor is configured to respectively generate a plurality of output feature maps from the self-attention modules according to classification of the feature map groups.

11. A convolutional neural network training method, comprising:
receiving a plurality of pieces of data corresponding to a plurality of leads;
generating a plurality of feature map groups respectively corresponding to the leads according to the pieces of data;
classifying the feature map groups to a plurality of self-attention modules according to a plurality of labels of the feature map groups, wherein the self-attention modules have different functions, and wherein the labels correspond to a plurality of diseases, respectively; and
generating a plurality of output feature map according to the feature map groups, by the self-attention modules.

12. The convolutional neural network training method of claim 11, wherein each of the self-attention modules has a plurality of weights corresponding to one of the leads.

13. The convolutional neural network training method of claim 11, further comprising:
inputting the output feature maps to a fully connected neural network to generate a plurality of output values according the output feature maps, wherein the output values are respectively correspond to the labels.

14. The convolutional neural network training method of claim 11, further comprising:
inputting the pieces of data corresponding to the leads to a plurality of residual neural network groups, respectively, to generate the feature map groups corresponding to the leads, respectively.

15. The convolutional neural network training method of claim 14, wherein each of the residual neural network groups comprises a plurality of continuous residual neural networks, wherein a first one of the continuous residual neural networks comprises a convolutional neural network and a mixed layer, and wherein the convolutional neural network training method further comprising:
generating a first feature map according to one of the pieces of data corresponding to one of the leads, by the convolutional neural network;
shuffle a sequence of the first feature map in a batch dimension to generate a second feature map, by the mixed layer;
mix the first feature map and the second feature map to generate a third feature map according to a mixed model, by the mixed layer;
generating a fourth feature map according to the third feature map and the one of the pieces of data, by the first one of the continuous residual neural networks; and
transmitting the fourth feature map as an input data to a second one of the continuous residual neural networks, by the first one of the continuous residual neural networks.

16. The convolutional neural network training method of claim 14, wherein the mixed model is MixStyle(F, F′), wherein,
$$MixStyle ( F , {F}^{′} ) = {γ}_{mix} ⊙ \frac{F - μ ( F )}{σ ( F )} + {β}_{m i x} ; \\ {γ}_{mix} = λσ ( F ) + ( 1 - λ ) σ ( {F}^{′} ) ; \\ {β}_{m i x} = λ μ ( F ) + ( 1 - λ ) μ ( {F}^{′} ) ;$$
wherein if a variable F is substituted by the first feature map, and a variable F′ is substituted by the second feature map, a calculated value of the mixed model is the third feature map.

17. The convolutional neural network training method of claim 14, wherein the convolutional neural network comprises a batch normalization layer, a linear rectifier function layer, a convolutional layer, and a compression and excitation layer.

18. The convolutional neural network training method of claim 11, further comprising:
masking a part of weights with relatively small values, by each of the self-attention modules, such that a sum of the part of the weights is 0.

19. The convolutional neural network training method of claim 18, further comprising:
in response to that the part of the weights with relatively small values are masked by each of the self-attention modules, adjusting values of the other part of the weights with relatively large values, by the self-attention modules correspondingly.

20. The convolutional neural network training method of claim 11, further comprising:
generating a plurality of output feature maps from the self-attention modules, respectively, according to classification of the feature map groups.
